(19) United States
(12) Patent Application Publication
(10) Pub. No.: US 2014/0172697 A1
(43) Pub. Date: Jun. 19, 2014

(54) SYSTEMS AND METHODS FOR DETECTING FRAUD IN RETAIL RETURN TRANSACTIONS

(71) Applicant: FIRST DATA CORPORATION, Greenwood Village, CO (US)

(72) Inventors: Theresa Ward, Atlanta, GA (US); Mark Steven Wallin, Sugar Land, TX (US)

(73) Assignee: FIRST DATA CORPORATION, Greenwood Village, CO (US)

(21) Appl. No.: 14/134,924

(22) Filed: Dec. 19, 2013

Related U.S. Application Data
(60) Provisional application No. 61/739,494, filed on Dec. 19, 2012.

(51) Int. Cl. G06Q 20/40

(52) U.S. Cl. CPC G06Q 20/4016
USPC 705/39

(57) ABSTRACT

This disclosure describes systems, methods, and computer-readable media related to detecting fraud in retail return transactions. In some embodiments, one or more parameters associated with a retail transaction may be received by at least one server comprising one or more computer processors. The server may evaluate the one or more risk factor conditions associated with the one or more parameters. The risk factor conditions may be indicative of a fraudulent return transaction. The server may generate one or more risk scores associated with the retail transaction based at least in part on the evaluating of the one or more risk factor conditions.

### RELATED APPLICATIONS

This application claims priority to U.S. Provisional Patent Application No. 61/739,494, entitled “Systems and Methods for Detecting Fraud in Retail Return Transactions,” filed on Dec. 19, 2012, the contents of which are incorporated by reference herein in their entirety.

### TECHNICAL DISCLOSURE

Embodiments of this disclosure relate generally to retail transactions and more specifically to systems and methods for detecting fraud in retail return transactions.

### BACKGROUND

Merchants often accept returns on merchandise previously purchased and either return cash to the customer or offer in-store credit for the returned items. However, many of these transactions can be fraudulent in nature, and it may be difficult to detect fraud in these transactions until after the return has been processed and payment has been remitted to the customer. In some situations, the returned item may have been stolen, the returned item may be counterfeit, or the time for returning the item may have lapsed. These fraudulent return transactions may cost the merchant significant amounts.

### BRIEF DESCRIPTION OF THE DISCLOSURE

This disclosure relates to systems and methods for detecting fraud in retail return transactions. In one embodiment, a computer-implemented method may be provided. The method may include receiving, by at least one server comprising one or more computer processors, one or more parameters associated with a retail transaction; evaluating, by the at least one server, one or more risk factor conditions associated with the one or more parameters, wherein the risk factor conditions are indicative of a fraudulent return transaction; and generating, by the at least one server, one or more risk scores associated with the retail transaction based at least in part on the evaluating of the one or more risk factor conditions.

In one aspect of an embodiment, the method may include generating, by the at least one server, a recommended course of action based at least in part on the one or more generated risk scores; and transmitting, by the at least one server, the recommended course of action to a merchant device.

In one aspect of an embodiment, the recommended course of action may include transmitting a notification to the merchant device to prevent a completion of the retail transaction based at least in part on one or more risk scores.

In one aspect of an embodiment, generating the one or more risk scores associated with the retail transaction may further include retrieving, by the at least one server, data associated with a customer initiating the retail transaction; and generating, by the at least one server, the one or more risk scores based at least in part on the retrieved data associated with the customer.

In one aspect of an embodiment, the data associated with the customer may include at least one of historical transaction data associated with the customer, previous payment data associated with the customer, an identifier associated with the customer, or purchase history of the customer.

In one aspect of an embodiment, the method may further include retrieving, by the at least one server, data associated with the customer from at least one of one or more serve providers or one or more government databases.

In one aspect of an embodiment, the method may further include analyzing, by the at least one server, the data associated with the customer and the one or more parameters associated with the retail transaction, wherein analyzing the data comprises pattern matching to identify similarities between data associated with the customer and the one or more parameters associated with the retail transaction.

In another embodiment, a computer-readable medium may store computer-executable instructions which, when executed by a processor, cause the processor to perform operations, including receiving one or more parameters associated with a retail transaction; evaluating one or more risk factor conditions associated with the one or more parameters, wherein the risk factor conditions are indicative of a fraudulent return transaction; and generating one or more risk scores associated with the retail transaction based at least in part on the evaluating of the one or more risk factor conditions.

In one aspect of an embodiment, the operations may further include generating a recommended course of action based at least in part on the one or more generated risk scores; and transmitting the recommended course of action to a merchant device.

In one aspect of an embodiment, the recommended course of action may include transmitting a notification to the merchant device to prevent a completion of the retail transaction based at least in part on one or more risk scores.

In one aspect of an embodiment, generating the one or more risk scores associated with the retail transaction may include retrieving data associated with a customer initiating the retail transaction; and generating the one or more risk scores based at least in part on the retrieved data associated with the customer.

In one aspect of an embodiment, the data associated with the customer may include at least one of historical transaction data associated with the customer, previous payment data associated with the customer, an identifier associated with the customer, or purchase history of the customer.

In one aspect of an embodiment, the operations may further include retrieving data associated with the customer from at least one of one or more serve providers or one or more government databases.

In one aspect of an embodiment, he operations may further include analyzing the data associated with the customer and the one or more parameters associated with the retail transaction, wherein analyzing the data comprises pattern matching to identify similarities between data associated with the customer and the one or more parameters associated with the retail transaction.

In another embodiment, a system may include at least one memory storing computer-executable instructions; and at least one processor, wherein the at least one processor is configured to access the at least one memory and to execute the computer-executable instructions to receive one or more parameters associated with a retail transaction; evaluate one or more risk factor conditions associated with the one or more parameters, wherein the risk factor conditions are indicative of a fraudulent return transaction; and generate one or more risk scores associated with the retail transaction based at least in part on the evaluating of the one or more risk factor conditions.

In one aspect of an embodiment, the at least one processor may be further configured to execute the computer-executable instructions to generate a recommended course of action based at least in part on the one or more generated risk scores; and transmit the recommended course of action to a merchant device.

In one aspect of an embodiment, the recommended course of action may include transmission of a notification to the merchant device to prevent a completion of the retail transaction based at least in part on one or more risk scores.

In one aspect of an embodiment, to generate the one or more risk scores associated with the retail transaction, the at least one processor may be further configured to execute the computer-executable instructions to retrieve data associated with a customer initiating the retail transaction; and generate the one or more risk scores based at least in part on the retrieved data associated with the customer.

In one aspect of an embodiment, the data associated with the customer may include at least one of historical transaction data associated with the customer, previous payment data associated with the customer, an identifier associated with the customer, or purchase history of the customer.

In one aspect of an embodiment, the at least one processor may be further configured to execute the computer-executable instructions to retrieve data associated with the customer from at least one of one or more serve providers or one or more government databases.

In one aspect of an embodiment, the at least one processor is further configured to execute the computer-executable instructions to analyze the data associated with the customer and the one or more parameters associated with the retail transaction, wherein analyzing the data comprises pattern matching to identify similarities between data associated with the customer and the one or more parameters associated with the retail transaction.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements, which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates a flow chart of an example retail fraud detection transaction in accordance with one or more embodiments of the disclosure.

FIG. 2 illustrates a block diagram of an example retail transaction fraud detection system in accordance with one or more embodiments of the disclosure.

FIG. 3 illustrates a flow diagram of an illustrative method for detecting fraud in retail return transactions in accordance with one or more embodiments of the disclosure.

FIG. 4 illustrates a flow diagram of another illustrative method for determining a risk score in accordance with one or more embodiments of the disclosure.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements. Like numbers refer to like elements throughout.

Embodiments of the disclosure now will be described more fully hereinafter with reference to the accompanying drawings, in which embodiments of the disclosure are shown. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Certain embodiments of the disclosure are directed to systems and methods for detecting fraud in retail return transactions. In certain embodiments, systems and methods can facilitate the detection of fraud for retail return transactions submitted by merchants via any number of transaction networks. In other embodiments of the disclosure, systems and methods can facilitate detecting fraud in merchant return transactions while processing the return transaction. In one example embodiment, historical information associated with retail return transactions submitted by a merchant may be collected from any number of suitable sources. For example, the merchant and/or any number of other external data sources may provide historical information. Furthermore, such information may be collected and stored in real time as transactions are routed from merchant devices (e.g., merchant point of sale (“POS”) devices, merchant electronic commerce servers, etc.) to authorization and/or settlement systems (e.g., financial institutions, payment account issuers, etc.) via the transaction networks.

Historical data may be retrieved from other service providers and merchants. For example, if a customer has interacted fraudulent transaction with a bank and the same customer attempts a suspicious return at a clothing store for example, the historical data from the fraudulent bank interaction may be utilized.

In one illustrative embodiment, the service provider system may collect historical data from a wide variety of transactional sources to form a database, “a risk database” where the information is used to identify possible risks in a transaction. Possible sources for such a risk database may include merchant or retailer databases, credit or debit card issuer databases, credit bureau databases, research and investigation fraud files, an ANI risk database, U.S. Postal Service NRI database, Account Takeover modeling and scoring, the Social Security administration, Department of Motor Vehicles, The American Business list, law enforcement, court and public information, phone directories and direct mail surveys, and entities that process checks, money orders and/or credit or stored value cards. One proprietary example of such a risk database may be the Consortium Risk Database® by First Data®.

In certain embodiments, historical transaction information may be evaluated and/or processed in order to identify transaction types that typically result in fraud based on data stored in a database configured to identify transactions that may pose a risk to the merchant. The data regarding historical transaction information may include, but is not limited to customer names, addresses, whether the customer had a valid identification, form of payment by the customer during the original purchase, type of item to be returned, and time of the year etc. The data regarding historical transactions may be compared against current return item information, customer information, business types or other evaluation metrics. Based on the historical data, a service provider may form a metric to evaluate or assess the risk of fraud in various types of transactions. During a transaction, the merchant's system may connect to a service provider system. In some embodiments, the merchant's system may be prompted to output relevant data regarding the particular transaction. The data may be outputted manually or collected automatically by scanning the potential return item for information. The data regarding the transaction may be transmitted to the service provider system to be analyzed in light of historical data and other metrics available. Based on the similarities to other transactions, the service provider system may determine a risk score for a particular transaction. Further, in certain embodiments, the service provider system may transmit this risk score to the merchant system. In some embodiments, the service provider system may transmit a recommendation for the transaction, based on one or more risk scores, to the merchant system. The recommendation may include: deny the transaction, approve an in-store credit, provide a partial refund, or provide a complete refund.

Embodiments of the disclosure now will be described more fully hereinafter with reference to the accompanying drawings, in which certain embodiments are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

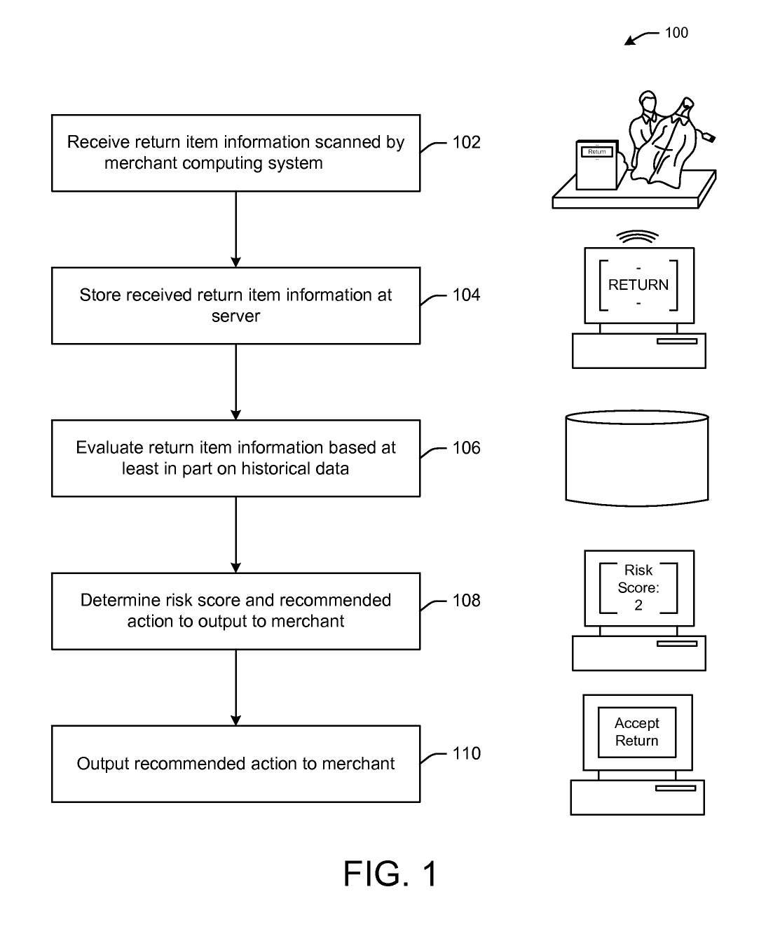

FIG. 1 illustrates a flow chart of an example retail fraud detection method which may be utilized in accordance with various embodiments of the disclosure. As shown in FIG. 1, in certain embodiments, the operations of the method may be performed by a suitable service provider computer and/or associated applications. Further, the operations illustrated in the method 100 may be performed in any order according to various embodiments of the disclosure.

At block 102, the service provider system may receive return item information scanned by a merchant computing system. The service provider system may receive identifying information on the return item such as the item's name, barcode, identification numbers, price, manufacturer etc. Information regarding the return item may be transmitted in real-time at the point of sale. At block 104, the service provider system may store information regarding the original purchase transaction in the database. The service provider may communicate with one or more databases for evaluating historical data. The databases may store information regarding the return item, merchant, customers etc.

At block 106, the service provider system may assess the return item information based at least in part on historical transaction information. The service provider system may query relevant historical information and compare the historical information with the information associated with the particular return item. Ultimately, the return item information may be used to evaluate the risk associated with accepting the returned item. In some embodiments, the service provider system may create an automatic query to compare information associated with the return item transaction with fraud information stored in the consortium risk database. In one example, the service provider system may perform a pattern matching to identify similar transactions.

At block 108, the service provider system may determine a risk score and output it (e.g., present the risk score) to the merchant. The score may be based at least in part on previous historical transactions which may be associated with any combination of factors, which may include, but are not limited to, information associated with the customer, information associated with the merchant, and/or information associated with the return item. The score may indicate to a merchant the level of risk in accepting the retail return transaction. In one embodiment, the scoring system may be unique to each merchant. The merchant may have the options of submitting various transactions with identified risk scores for comparison. The service provider system may use the identified risk scores from various merchants to form a comparison and output a score for the merchant.

At block 110, the service provider system may output a recommended course of action to the merchant. For example, if the service provider system determines that the risk is high, the service provider system may recommend that the merchant deny the return. If the service provider system determines that the risk is low, the service provider system may recommend a cash or credit return. For risks that are in-between, any number of recommendations may be provided. These recommendations may include, but are not limited to, in-store credit, in-store exchange, processing a return after verification, cash or credit credited to the customer, amount of return placed on a gift card or the like.

It should be noted that the method 100 might be modified in various ways in accordance with certain embodiments of the disclosure. For example, one or more operations of the method 300 may be eliminated or executed out of order in other embodiments of the disclosure. Additionally, other operations may be added to the method 100 in accordance with other embodiments of the disclosure.

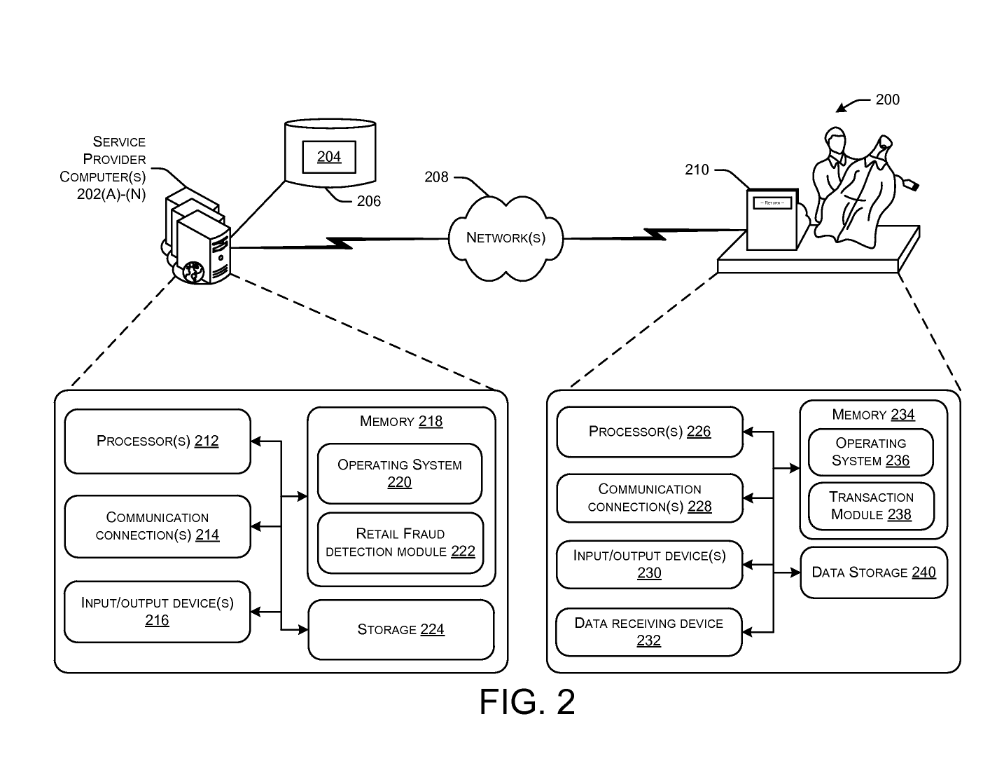

FIG. 2 illustrates a block diagram of an example system 200 that may be utilized in accordance with various embodiments of the disclosure to facilitate the detection of fraud in retail return transactions. As shown in FIG. 2, the system 200 may include one or more service provider computers 202(A)-(N) (known herein as “service provider computer 202”) and/or merchant devices 210. In certain embodiments, communications between the service provider system 202 and the merchant devices 210 may be facilitated via one or more suitable networks 208, such as the Internet, etc.

With continued reference to FIG. 2, the service provider computer 202 may obtain and store information associated with historical transactions for retail transactions for merchants and other similar merchants. For example, historical transaction data may be stored in one or more historical transaction data databases 206. The database 206 may contain data files 204 for various merchants that are both similar, and dissimilar to the current merchant. In one example, data files from a fraudulent bank transaction may be compared with data files for a retail merchant. As desired, historical transaction, information may be obtained from a wide variety of suitable sources, such as the merchant device 210, any number of financial institution systems, government systems, police and criminal records and/or from any other suitable data sources (e.g., various acquiring platforms, transaction processing service providers, etc.). Additionally, as desired, the service provider computer 202 can obtain information specific to the particular merchant based on the merchant's indicated preferences.

With continuing reference to FIG. 2, any number of service provider computers 202 may be provided. A service provider computer 202 may include any number of processor-driven devices, including, but not limited to, a server computer, a personal computer, one or more networked computing devices, an application-specific circuit, a minicomputer, a microcontroller, and/or any other processor-based device and/or combination of devices. A service provider computer 202 may utilize one or more processors 212 to execute computer-readable instructions that facilitate the general operation of the service provider computer 202 and/or provisions of the retail fraud detection module.

In addition to having one or more processors 212, the service provider computer 202 may further include one or more memory devices 218(generally referred to as memory), one or more input/output (“I/O”) interface(s) 216, and/or one or more communication connections 214. The communication connections 214 may interface with the database 206, which may contain one or more data files, such as 204, which may include historical data. For example, the data files 204 may include information associated with one or more merchant devices 210, historical information associated with one or more retail return transactions, merchant rules and/or parameters, customer information, customer identification, form of payment, type of retail item, customer information regarding similar merchants, etc.

The memory 218 may be any computer-readable medium, coupled to the one or more processors 212, such as random access memory (“RAM”), read-only memory (“ROM”), and/or removable storage devices. The memory 218 may store one or more program modules utilized by the service provider computer 202, such as an operating system (OS) 220. The one or more program modules may include a retail fraud detection module 222.

Certain embodiments may be provided as a computer program product including a non-transitory machine-readable storage medium having stored thereon instructions (in compressed or uncompressed form) that may be used to program a computer (or other electronic device) to perform processes or methods described herein. For example, certain embodiments may be provided as a computer program product or group of products that may be executed by the service provider computers 202 or other suitable computing systems. The machine-readable storage medium may include, but is not limited to, hard drives, floppy diskettes, optical disks, CD-ROMs, DVDs, read-only memories (“ROMs”), random access memories (“RAMs”), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks. For example, distribution of software may be Internet download.

With reference to the contents of the memory 218, the data files 206 may include any suitable data that facilitates the operation of the service provider computer 202 and/or interaction of the service provider computer 202 with one or more other components of the system 200.

The OS 220 may be any suitable module that facilitates the general operation of the service provider computer 202, as well as the execution of other program modules. The one or more program modules, such as the retail fraud detection module 222, may include one or more suitable software modules and/or applications configured detect fraud in a retail return transaction based at least in part on one or more historical transactions. Additionally, the retail fraud detection module 222 may be configured to receive a wide variety of user input from a merchant device 210 and to process the received user input to modify presentations and/or to provide predictions and/or estimations associated with transaction routing.

The retail fraud detection module 222 may retrieve historical information associated with one or more retail return transactions submitted by a merchant that may be collected from any number of suitable sources. For example, historical transaction information may be accessed from the database 206 or received from one or more merchant devices 210 (e.g., received via batch files and/or other asynchronous communications, etc.).

In one example, the database 206 may be used for pooling data from a variety of sources to access risk. In one example, the database 206 may be configured to store data regarding various events known as “trigger events.” Trigger events may be used by the service provider to identify potentially risky transaction. The trigger events may be gathered through data retrieval from various merchant systems. In one illustrative example, the merchant systems may queue a daily statistics report to identify all accounts that may match criteria for transmitting the transaction into the database. These statistics reports may identify account sources and identifiers. Further, the daily statistics reports may be used to categorize various types of merchants. One example of such a database may be the Consortium Risk Database®.

The service provider system 202 may track contributor's daily statistics reports from a plurality of merchant systems, as well as other sources that may interact with similar user accounts and customer accounts. Further, the service provider may compare the factors involved in those transactions with other merchant transactions and use the comparison to identify fraudulent transactions for a particular merchant system. When comparing the transactions, the service provider system 202 may take into account similarity between transactions by generating a weighted comparison. Identifying the fraudulent transactions may allow the service provider-to-provider real-time or near-real time recommendations to a merchant system.

The retail fraud detection module 222 may evaluate the historical transaction information and identify factors from the historical transaction information that may be associated with fraudulent retail return transactions. In this regard, a wide variety of statistical information and/or representative information associated with the transactions across many platforms may be included for analysis.

The retail fraud detection module 222 may determine and identify factors associated with retail return transaction fraud. In certain embodiments, the retail fraud detection module 222 may evaluate the factors and identify a risk score based on historical transactions. In certain embodiments, the retail fraud detection module 222 may transmit the risk score to the merchant device 210. In other embodiments, the retail fraud detection module 222 may identify a recommended action based on the risk score. For example, if a retail return transaction has a relatively low risk score, the retail fraud detection module 222 may recommend that the merchant accept the returned item and offer a cash refund. However, if for example, the retail return transaction has a relatively high-risk score, the retail fraud detection module 222 may recommend that the merchant reject the retail return transaction. In other situations, based on at least a predefined risk score or range of risk scores, the retail fraud detection module 222 may recommend that the merchant offer in-store credit or exchange of merchandise only. In any instance, these recommendations may be transmitted to the merchant device 210, using one of the communications connections 214, via one or more network 208.

In illustrative example, the retail fraud detection module 222 may further communicate an alert to a police station in the event of a detection of a relatively high score retail transaction (e.g., high score exceeds a pre-determined threshold). In other embodiments, the retail fraud detection module 222 may retrieve identification information associated with a high-risk retail transaction and transmit an alert to other merchant devices to block the user identified by the user identification information from returning retail items.

The merchant device 210 may include any computing device capable of processing a transaction, including, but not limited to, a computer, mobile device, scanning device, a point-of-sale device (POS), cash register, or the like. The merchant device 210 may include one or more processors 226. The one or more processors 226 may be implemented as appropriate in hardware, software, firmware, or combinations thereof. Software or firmware implementations of the one or more processors 226 may include computer-readable or machine-readable instructions written in any suitable programming language to perform the various functions described. The merchant device 210, in addition to having one or more processors 226, may further include one or more memory devices 234 (generally referred to as memory 234), one or more input/output (“I/0”) interface(s) 230, and/or one or more communication connections 228. The communications connections 228 may interface with the network 208 to transmit transaction information for a particular retail transaction. The merchant device 210 may be configured with one or more data receiving devices 232 to retrieve or scan data from a barcode reader, NFC reader or other such readers.

Similar to memory 218 above, the memory 234 may be any computer-readable medium, coupled to the one or more processors 226 of the merchant device 210, such as random access memory (“RAM”), read-only memory (“ROM”), and/or removable storage devices. The memory 234 may store one or more program modules utilized by the merchant device 210, such as an operating system (OS) 236. The one or more program modules may include a transaction module 238

The one or more I/O interfaces 230 may facilitate communication with the service provider computer 202. For example, one or more user interface devices can include, but are not limited to, a display, a keypad, a keyboard, a touch screen display, a microphone, a speaker, a mouse, or any other similar device that can facilitate user interaction. The one or more networks 208 and/or communication connections 228 may facilitate connection of the service provider computer 202 to any number of suitable networks, for example, the one or more network(s) 208, illustrated in FIG. 2. In this regard, the service provider computer 202 may receive and/or communicate information to other components of the system 200.

With continued reference to FIG. 2, any number of merchant devices 210 may be included in the system 200. A merchant device 210 may be configured to access one or more services hosted by the service provider computers 202 in order to review, augment, retrieve, and/or manipulate historical transaction information. Additionally, in certain embodiments, a merchant device 210 may be configured to provide historical transaction information (e.g., batch files of historical transaction information, etc.) and/or various merchant preferences to the service provider computers 202 for processing and evaluation. In certain embodiments, a merchant device 210 may include similar components as those discussed above for the service provider computer 202. For example, a merchant device 210 may include any number of processors, memories, I/O interfaces, and/or network/communication interfaces.

A wide variety of suitable networks, such as 208, (which may be the same or separate networks) and/or communication channels may be utilized to facilitate communications between the merchant devices 210, the service provider computers 202 and/or other components of the system 200. These networks 208 may include, but are not limited to, one or more telecommunication networks, cellular networks, wide area networks (e.g., the Internet), and/or local area networks. Various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

In certain embodiments, the service provider computers 202 or the merchant device 110 may be configured to capture transaction information as transactions are routed from one or more data receiving devices 232. For example, a data receiving device 232 may retrieve information affixed to or otherwise associated with a returned retail item. The data receiving device 232 may scan the returned retail item for data, which may include purchase date, particular item identification codes, price, location of purchase, etc. The received data may be transmitted to the service provider device 202 via one of the communication connections 230.

With reference to the memory 234 of the merchant device 210, the transaction module 238 may retrieve data from the data receiving device 232 relating to the particular retail return transaction. The transaction module 238 may initiate a request to detect a fraudulent retail return transaction. The transaction module 238 may receive transmitted results and at least one recommendation from the service provider computer 202. The transaction module 238 may output or otherwise display the at least one recommendation to the merchant device 210 from the service provider computer 202. In other illustrative embodiments, the transaction module 238 may be configured to block the processing of a particular transaction based on the recommendation. For example, the transaction module 238 can facilitate the deactivation of the data receiving device 232. In other embodiments, the transaction module 238 may be configured to automatically decline the remittance of any payment based on the recommendation.

The system 200 shown in and described with respect to FIG. 2 is provided by way of example only. Numerous other operating environments, system architectures, and device configurations are possible. Other system embodiments can include fewer or greater numbers of components and may incorporate some or all of the functionality described with respect to the system components shown in FIG. 2. Accordingly, embodiments of the disclosure should not be construed as being limited to any particular operating environment, system architecture, or device configuration.

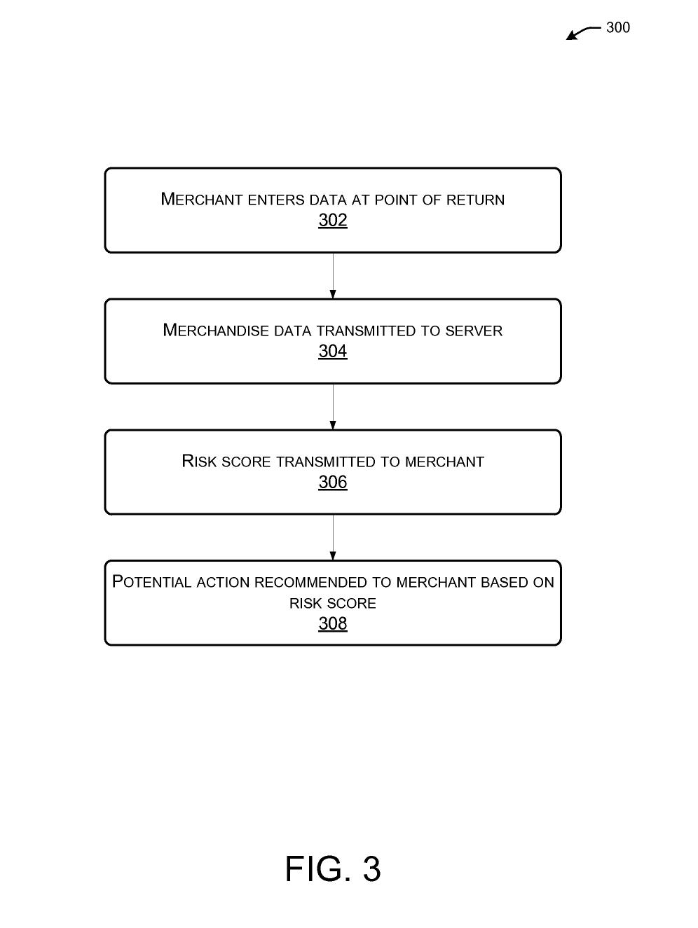

FIG. 3 illustrates a flow diagram of an example process 300 for detecting fraudulent retail fraud transactions, according to at least one embodiment of the system. In certain embodiments, the operations of the method 300 may be performed by a suitable service provider computer 202 and/or associated applications, such as the retail fraud detection module 222. At block 302, a user operating the merchant device 210 may enter data at a point of return, such as at a retail establishment. The merchant may have a data receiving device, such as 232, to scan a returned retail item. Data from the returned retail item can be transmitted from the data receiving device to the merchant device 210. In some instances, to facilitate the retail return transaction, the merchant may also manually enter data pertaining to the retail return transaction. For example, the merchant may scan a bar code associated with the returned retail item. The merchant device 210 may receive an input of credit card information from the customer and customer identification information, such as a driver's license number, a social security number, or a passport number. Other data pertaining to the retail establishment and the returned retail item may also be input by the merchant, and ultimately stored on the merchant device 210.

At block 304, information associated with the retail return transaction and any number of historical transactions may be submitted to the service provider computer 202. In certain embodiments, information may be identified for a predetermined historical period of time, such as the previous month, etc. As desired, information may also be identified in accordance with any number of other metrics (e.g., geographical area, merchant POS devices, merchant locations, type of item, value of item, total number of sales etc.).

At block 306, a risk score may be transmitted to the merchant. The service provider computer 202 may generate and transmit a risk score to the merchant pertaining to the particular transaction. The risk score may indicate the likelihood that the transaction is fraudulent. In one illustrative example, the risk score may be customized to the merchant. The merchant device 210 may transmit test transactions to the service provider computer 202 with various scoring information. The service provider computer 202 may perform a pattern matching to identify similarities between test transactions and the current retail transactions. The risk score may be outputted to display on the merchant device 210.

At block 308, potential actions may be transmitted as recommendations to the merchant device 210 based on the risk score. The risk score, generated by the service provider computer 202, may indicate the likelihood that the transaction is fraudulent. Based on the risk score, the merchant may be presented with possible recommendations generated and transmitted by the service provider computer 202. In some embodiments, the recommended action may be outputted to display on the merchant device 210. In some embodiment, the recommended action may be outputted to display on the merchant device 210

It should be noted that the method 300 may be modified in various ways in accordance with certain embodiments of the disclosure. For example, one or more operations of the method 300 may be eliminated or executed out of order in other embodiments of the disclosure. Additionally, other operations may be added to the method 100 in accordance with other embodiments of the disclosure.

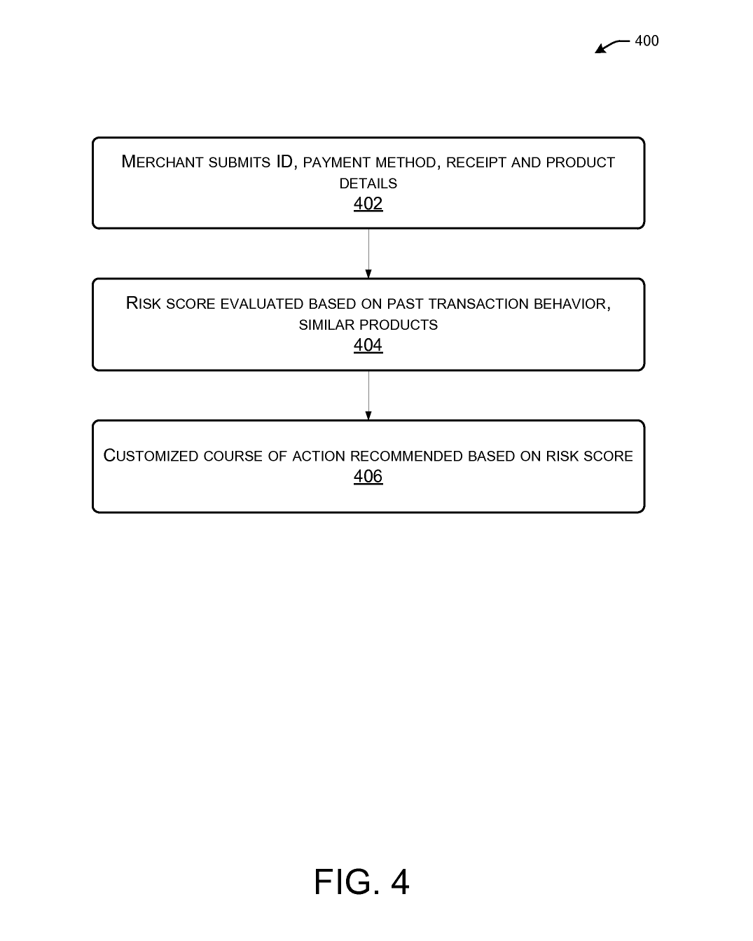

FIG. 4 illustrates a flow chart of an example process 400 for determining a risk score. In certain embodiments, the operations of the method 400 may be performed by a suitable service provider computer and/or associated applications.

The method 400 may begin at operation block 402. At block 402 the merchant may submit ID, payment methods, receipt and product details. The merchant may scan the information automatically. Alternatively, the merchant may input the data or retrieve the data from a server or a database. In any instance, the information can be transmitted to the service provider computer 202 for processing and/or storage.

At block 404, a risk score may be evaluated based on past transaction behavior. The service provider computer 202 may retrieve relevant information from other service providers, government databases such as criminal records or other public records, other merchants and other locations for this merchant. All of this information may be used by the service provider computer 202 to generate a risk score to evaluate a risk associated with the transaction.

At block 406, a course of action may be recommended to the merchant based on the transaction. For example, for relatively high risk scores, the service provider computer 202 may determine a course of action, which may be that the transaction be denied. For medium risk scores, the service provider computer 202 may determine a recommendation, which may be for in-store credit or a partial refund. In other situations, the service provider computer 202 may determine a recommendation, which may be for a full refund.

It should be noted that the method 400 may be modified in various ways in accordance with certain embodiments of the disclosure. For example, one or more operations of the method 400 may be eliminated or executed out of order in other embodiments of the disclosure. Additionally, other operations may be added to the method 400 in accordance with other embodiments of the disclosure.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

What is claimed is:

1. A computer-implemented method comprising:
receiving, by at least one server comprising one or more computer processors, one or more parameters associated with a retail transaction;
evaluating, by the at least one server, one or more risk factor conditions associated with the one or more parameters, wherein the risk factor conditions are indicative of a fraudulent return transaction; and
generating, by the at least one server, one or more risk scores associated with the retail transaction based at least in part on the evaluating of the one or more risk factor conditions.

2. The computer-implemented method of claim 1, further comprising:
generating, by the at least one server, a recommended course of action based at least in part on the one or more generated risk scores; and
transmitting, by the at least one server, the recommended course of action to a merchant device.

3. The computer-implemented method of claim 2, wherein the recommended course of action comprises transmitting a notification to the merchant device to prevent a completion of the retail transaction based at least in part on one or more risk scores.

4. The computer-implemented method of claim 1, wherein generating the one or more risk scores associated with the retail transaction further comprises:
retrieving, by the at least one server, data associated with a customer initiating the retail transaction; and
generating, by the at least one server, the one or more risk scores based at least in part on the retrieved data associated with the customer.

5. The computer-implemented method of claim 4, wherein the data associated with the customer comprises at least one of historical transaction data associated with the customer, previous payment data associated with the customer, an identifier associated with the customer, or purchase history of the customer.

6. The computer-implemented method of claim 4, further comprising:
retrieving, by the at least one server, data associated with the customer from at least one of one or more serve providers or one or more government databases.

7. The computer-implemented method of claim 4, further comprising:
analyzing, by the at least one server, the data associated with the customer and the one or more parameters associated with the retail transaction, wherein analyzing the data comprises pattern matching to identify similarities between data associated with the customer and the one or more parameters associated with the retail transaction.

8. A computer-readable medium storing computer-executable instructions which, when executed by a processor, cause the processor to perform operations comprising:
receiving one or more parameters associated with a retail transaction;
evaluating one or more risk factor conditions associated with the one or more parameters, wherein the risk factor conditions are indicative of a fraudulent return transaction; and
generating one or more risk scores associated with the retail transaction based at least in part on the evaluating of the one or more risk factor conditions.

9. The computer-readable medium of claim 8, wherein the operations further comprise:
generating a recommended course of action based at least in part on the one or more generated risk scores; and
transmitting the recommended course of action to a merchant device.

10. The computer-readable medium of claim 9, wherein the recommended course of action comprises transmitting a notification to the merchant device to prevent a completion of the retail transaction based at least in part on one or more risk scores.

11. The computer-readable medium of claim 8, wherein generating the one or more risk scores associated with the retail transaction further comprises:
retrieving data associated with a customer initiating the retail transaction; and
generating the one or more risk scores based at least in part on the retrieved data associated with the customer.

12. The computer-readable medium of claim 11, wherein the data associated with the customer comprises at least one of historical transaction data associated with the customer, previous payment data associated with the customer, an identifier associated with the customer, or purchase history of the customer.

13. The computer-readable medium of claim 11, wherein the operations further comprise:
retrieving data associated with the customer from at least one of one or more serve providers or one or more government databases.

14. The computer-readable medium of claim 11, wherein the operations further comprise:
analyzing the data associated with the customer and the one or more parameters associated with the retail transaction, wherein analyzing the data comprises pattern matching to identify similarities between data associated with the customer and the one or more parameters associated with the retail transaction.

15. A system comprising:
at least one memory storing computer-executable instructions; and
at least one processor, wherein the at least one processor is configured to access the at least one memory and to execute the computer-executable instructions to:
receive one or more parameters associated with a retail transaction;
evaluate one or more risk factor conditions associated with the one or more parameters, wherein the risk factor conditions are indicative of a fraudulent return transaction; and
generate one or more risk scores associated with the retail transaction based at least in part on the evaluating of the one or more risk factor conditions.

16. The system of claim 15, wherein the at least one processor is further configured to execute the computer-executable instructions to:
generate a recommended course of action based at least in part on the one or more generated risk scores; and
transmit the recommended course of action to a merchant device.

17. The system of claim 16, wherein the recommended course of action comprises transmission of a notification to the merchant device to prevent a completion of the retail transaction based at least in part on one or more risk scores.

18. The system of claim 15, wherein to generate the one or more risk scores associated with the retail transaction, the at least one processor is further configured to execute the computer-executable instructions to:
retrieve data associated with a customer initiating the retail transaction; and
generate the one or more risk scores based at least in part on the retrieved data associated with the customer.

19. The system of claim 18, wherein the data associated with the customer comprises at least one of historical transaction data associated with the customer, previous payment data associated with the customer, an identifier associated with the customer, or purchase history of the customer.

20. The system of claim 18, wherein the at least one processor is further configured to execute the computer-executable instructions to:
retrieve data associated with the customer from at least one of one or more serve providers or one or more government databases.

21. The system of claim 18, wherein the at least one processor is further configured to execute the computer-executable instructions to:
analyze the data associated with the customer and the one or more parameters associated with the retail transaction, wherein analyzing the data comprises pattern matching to identify similarities between data associated with the customer and the one or more parameters associated with the retail transaction.
